(19) United States
(12) Patent Application Publication
(10) Pub. No.: US 2007/0210054 A1
(43) Pub. Date: Sep. 13, 2007

(54) WASTE BIN ASSEMBLY

(76) Inventors: David Hallman, Bright (CA); Shawn Davidson, Plattsville (CA)

Correspondence Address: VALENTINE A COTTRILL, 50 QUEEN STREET NORTH, STE. 1020, P.O. BOX 2248, KITCHENER, ON, N2H6M2, US

(21) Appl. No.: 11/681,416

(22) Filed: Mar. 2, 2007

Related U.S. Application Data
(60) Provisional application No. 60/778,072, filed on Mar. 2, 2006.

(51) Int. Cl. F27D 11/00

(52) U.S. Cl. 219/385

(57) ABSTRACT

A waste bin assembly for the collection and storage of waste material. The waste bin assembly includes a bin with a floor and one or more walls extending from the floor to at least partially define a cavity. One or more of the floor and the walls includes one or more heating elements, for heating the waste material in the cavity. The waste bin assembly also includes a frame subassembly for supporting the bin. The frame subassembly includes two or more posts and one or more transverse members connecting the posts. The transverse member and the posts define one or more apertures in which one or more panels are positionable.

This application claims the benefit of U.S. Provisional Application No. 60/778,072, filed Mar. 2, 2006.

### FIELD OF THE INVENTION

This invention is related to waste bin assemblies.

### BACKGROUND OF THE INVENTION

Typical waste bins which are made for industrial and commercial use are constructed of sheet metal. In one commonly-used design, the waste bin includes parallel slots or tubes on its exterior, in which forks (one for each side) are receivable so that the waste bin can be unloaded into a front-loading waste disposal truck.

However, there are a number of problems with the all-metal waste bin of the prior art. First, in colder climates, the waste material may become frozen to the inside of the waste bin. This is particularly problematic where the waste material has a relatively high moisture content. Second, the prior art waste bins also tend to become dented, and deformed, over time. In addition, the sides of the prior art waste bin tend to become dirty due to garbage which spills onto its sides, usually during the unloading of the waste bin. Finally, the prior art waste bin tends to become rusty in places, and therefore becomes somewhat unsightly, so that frequent repainting is necessary.

There is therefore a need for an improved waste bin which addresses or mitigates one or more of the defects of the prior art.

### SUMMARY OF THE INVENTION

In its broad aspect, the invention provides a waste bin assembly for the collection and temporary storage of waste material. The waste bin assembly includes a bin having a floor and one or more walls extending from the floor to at least partially define a cavity. One or more of the floor and the walls include one or more heating elements for heating the waste material in the cavity. The waste bin assembly also includes a frame subassembly for supporting the bin. The frame subassembly includes two or more posts and one or more transverse members connecting the posts. The transverse member and the posts define one or more apertures in which one or more panels are positionable.

In another aspect, the walls include thermal insulation to retard heat transfer out of the cavity.

In yet another aspect, the floor includes thermal insulation to retard heat transfer out of the cavity.

In another aspect, the heating element is self-regulating.

In another of its aspects, the invention provides a waste bin for the collection and storage of waste material. The waste bin includes a floor and one or more walls extending from the floor to at least partially define a cavity. One or more of the floor and the walls include one or more heating elements for heating the waste material in the cavity.

In another aspect, the walls include thermal insulation to retard heat transfer out of the cavity.

In yet another of its aspects, the floor includes thermal insulation to retard heat transfer out of the cavity.

In another aspect, the heating element is self-regulating.

### BRIEF DESCRIPTION OF THE DRAWINGS

The invention will be better understood with reference to the attached drawings, in which:

FIG. 1 is an isometric view of a preferred embodiment of the waste bin assembly of the invention;

FIG. 2 is a partially cut away isometric view of the waste bin assembly of FIG. 1;

FIG. 3A is an isometric view of a preferred embodiment of a frame subassembly of the invention;

FIG. 3B is an isometric view of an alternative embodiment of the frame subassembly of the invention;

FIG. 4 is an isometric view of a preferred embodiment of a tube of the invention having a stop portion in a closed position, drawn at a larger scale;

FIG. 5 is an isometric view of the tube of FIG. 4 with the stop portion in an open position;

FIG. 6 is an isometric view of the waste bin assembly of FIG. 1, drawn at a smaller scale;

FIG. 7 is another isometric view of the waste bin assembly of FIG. 6;

FIG. 8 is a cross-section of the waste bin assembly of FIG. 1, drawn at a larger scale;

FIG. 9 is another cross-section of the waste bin assembly of FIG. 1, taken orthogonal to the cross-section of FIG. 8;

FIG. 9a is a part of the cross-section of FIG. 9, drawn at a larger scale;

FIG. 10 is a side view of the waste bin assembly of FIG. 1, in an unloading position; and

FIG. 11 is a bottom view of an alternative embodiment of the invention, drawn at a larger scale.

### DETAILED DESCRIPTION

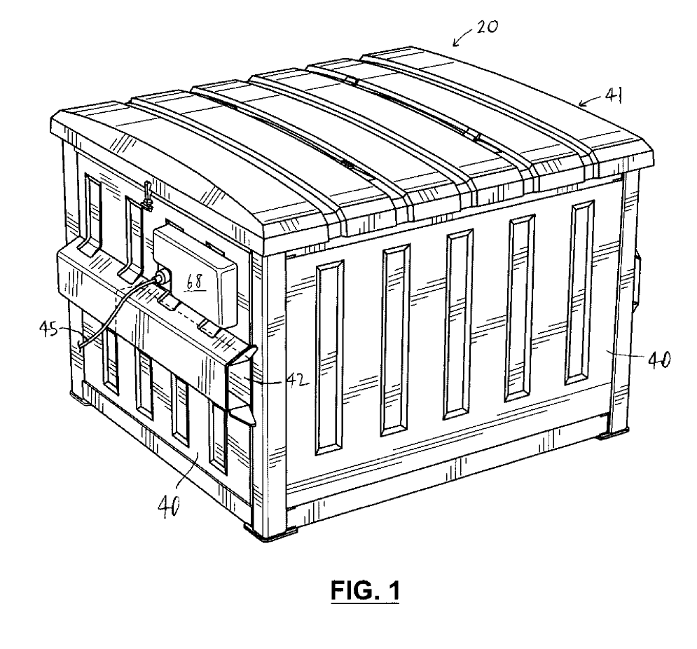

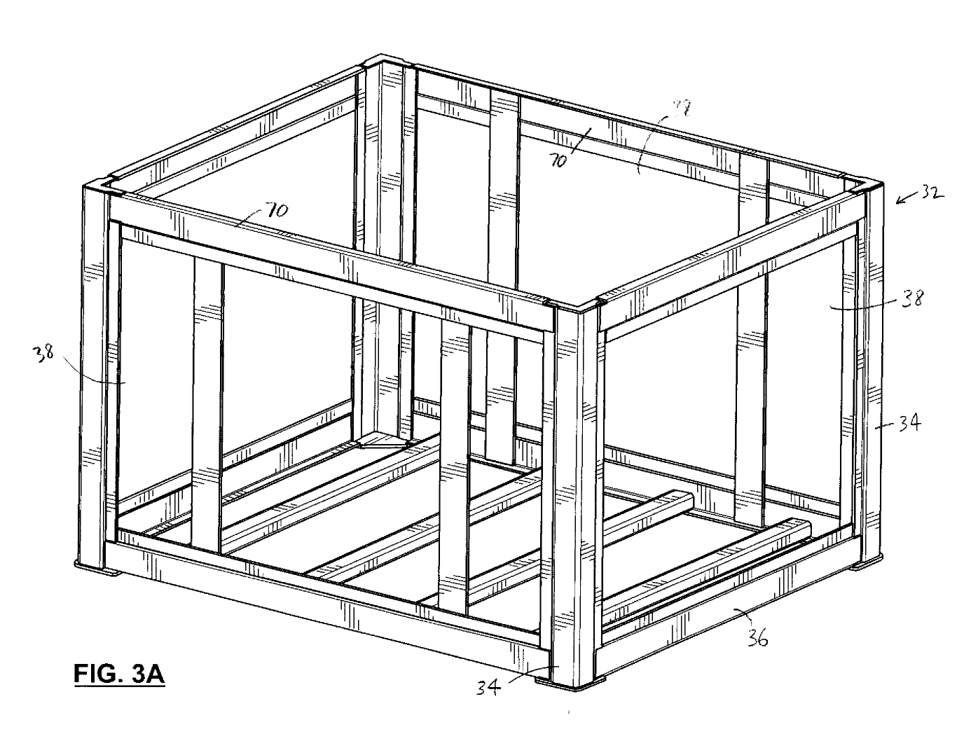

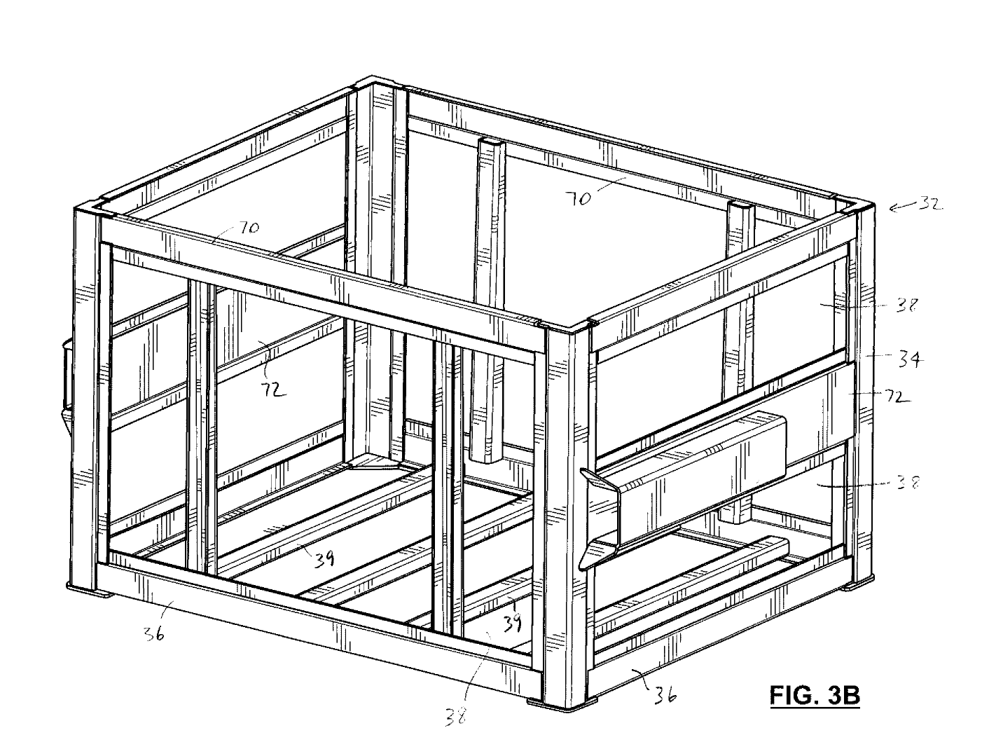

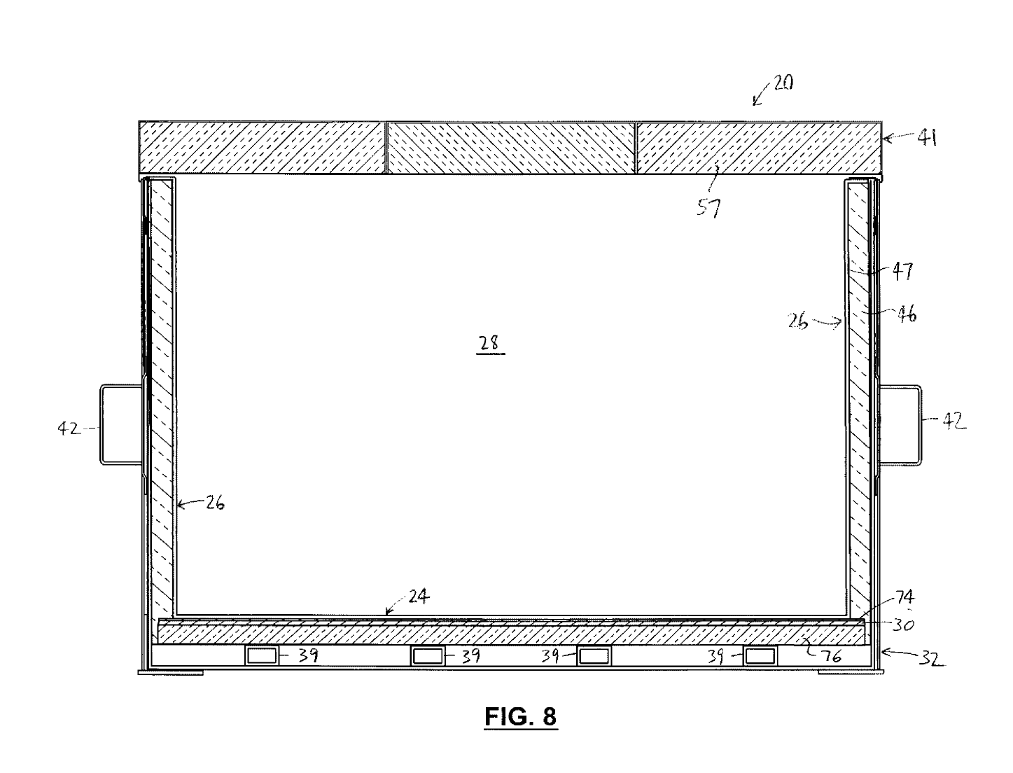

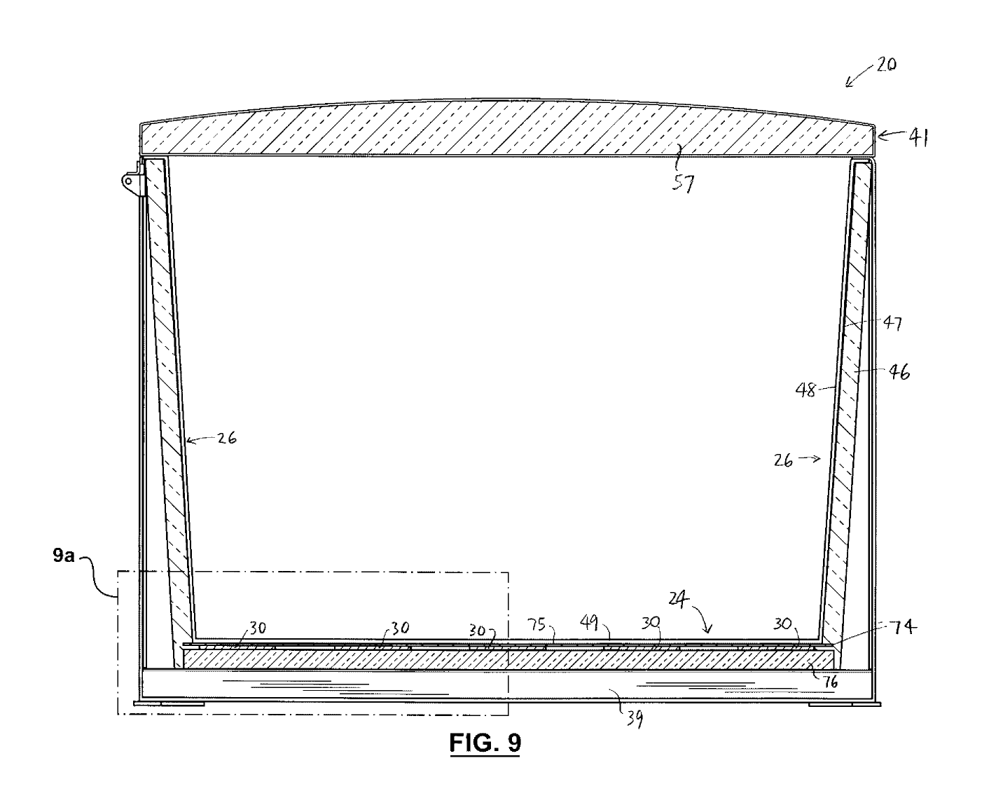

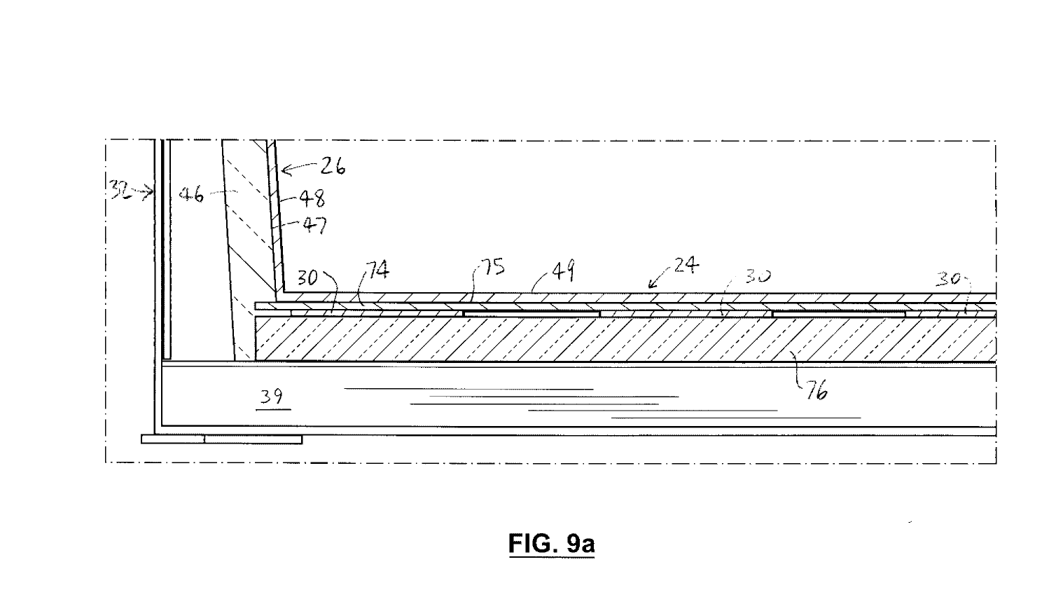

Reference is first made to FIGS. 1-10 to describe an embodiment of a waste bin assembly 20 of the invention. The waste bin assembly 20 is for the collection and storage of waste material. Preferably, the waste bin assembly 20 includes a bin 22 with a floor 24, and one or more walls 26 extending from the floor 24 to at least partially define a cavity 28 (FIGS. 8, 9). One of the floor 24 and the walls 26 (or one or more of the walls 26, as the case may be) includes a heating element 30 for heating the waste material (not shown) in the cavity 28, as will be described. It is also preferred that the waste bin assembly 20 includes a frame subassembly 32 for supporting the bin 22. The frame subassembly 32 includes two or more posts 34 and one or more transverse members 36 connecting the posts 34, as will also be described (FIGS. 3A, 3B). Preferably, the transverse member 36 and the posts 34 define one or more apertures 38 in which a panel 40 is positionable, as will also be described.

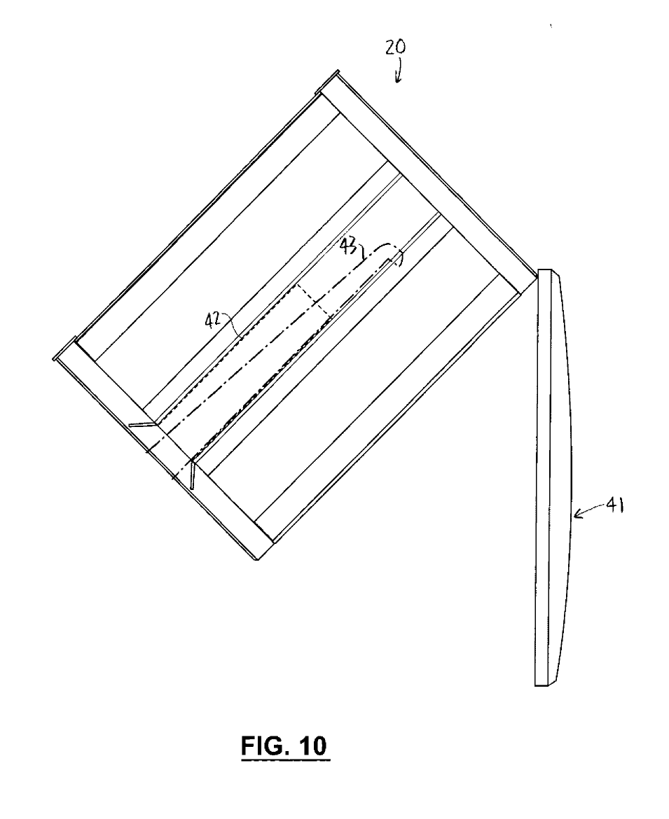

The waste bin assembly 20 preferably also includes a cover subassembly 41 which is movable between a closed position (FIG. 1) and an open position (FIG. 10). As can be seen in FIG. 10, the waste bin assembly 20 is unloaded by substantially inverting it, which causes the cover assembly 41 to move to the open position and also empties the bin 22 of its contents due to gravity. Preferably, the waste bin assembly 20 is unloaded into a waste disposal truck (not shown), as is known in the art.

In the preferred embodiment, the waste bin assembly 20 additionally includes two or more tubes 42 mounted on the frame subassembly 32, in which forks 43 (FIG. 10) of the waste disposal truck are receivable, to enable the waste disposal truck's self-loading mechanism to unload the bin, as shown in FIG. 10. As is known in the art, one fork 43 is inserted into each of the tubes 42 respectively. To simplify the illustration, only one fork 43 and one tube 42 are shown in FIG. 10.

Any suitable source of electrical energy may be used to provide electrical energy to the heating element 30. However, in practice, electrical energy preferably is provided via an electrical power cord 45 (FIG. 1) which is plugged into an available electrical outlet (e.g., at a nearby building) (not shown). As a practical matter, the power cord 45 preferably is disconnected before the waste bin assembly 20 is raised by the waste disposal truck and substantially inverted, to avoid damaging the cord 45 or any part of the waste bin assembly 20.

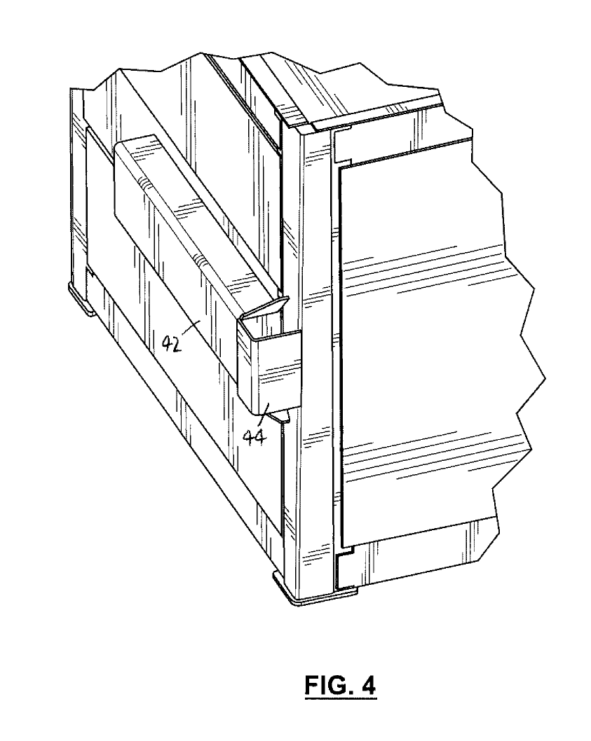

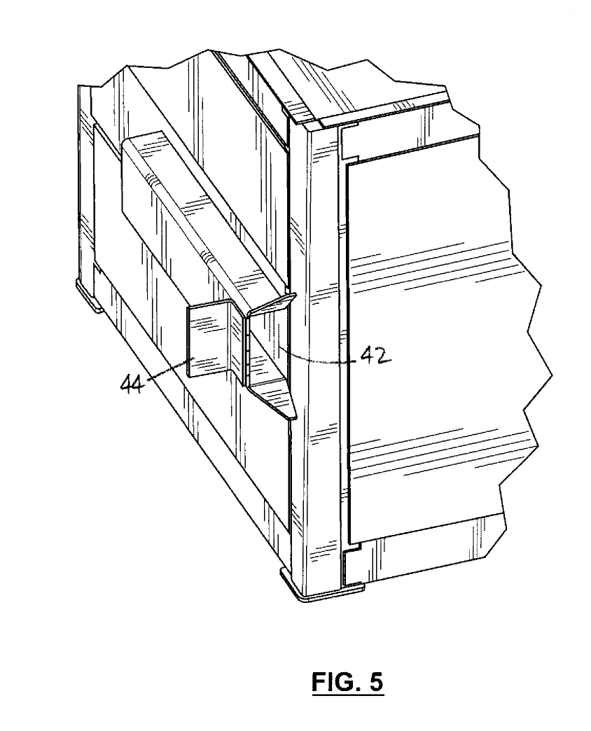

As can be seen in FIGS. 4 and 5, the waste bin assembly 20 preferably includes one or more stop portions 44 mounted on the tubes 42. Each stop portion 44 is movable between a blocking position (FIG. 4), in which the stop portion 44 prevents one of the forks 43 from entering one of the tubes 42, and a receiving position (FIG. 5), in which one of the forks 43 is receivable in one of the tubes 42. Preferably, the assembly 20 includes only one stop portion 44. (If the other tube 42 is not covered by another stop portion 44, then the forks 43 are receivable in the tubes 42 when the single stop portion 44 is in the receiving position.) Because of the stop portion 44, an operator (not shown) of a waste disposal truck is required to get out of the waste disposal truck and disconnect the electrical power cord 45 (FIG. 1) before the truck's forks 43 are inserted and the waste bin assembly 20 is lifted by the truck and inverted. Preferably, the stop portion 44 is positioned at the front end of the tube on the left-hand side (i.e., as illustrated in FIGS. 4 and 5), for the convenience of the operator of the waste disposal truck, assuming that the truck's operator is seated on a left side thereof. After the bin is unloaded, it is replaced on the ground, and the forks are removed from the tubes. Also, the cord 45 is reconnected.

It is also preferred that the walls 26 include thermal insulation 46, to retard heat transfer out of the cavity 28. Preferably, the floor 24 also includes thermal insulation 46, also for retarding heat transfer out of the cavity 28. The heating element 30 is adapted for limiting freezing of the waste material.

The bin walls 26 preferably are made of any suitable materials, e.g., a suitable sheet steel product. The bin walls have outer surfaces 47 on which the thermal insulation 46 is positionable, and inner surfaces 48 which are engaged by the waste material. Preferably, the thermal insulation 46 is sprayed onto the outer surfaces 47 of the walls 26, to form a layer of substantially consistent thickness on the outer surfaces 47 of the walls 26. It is preferred that the insulation is a polyurethane foam insulation. However, those skilled in the art would be aware of other types of suitable insulation.

The floor 24 includes an inner surface 49 which is engaged by the waste material. The inner surfaces 48, 49 of the walls 26 and the floor 24 preferably are suitable for engagement with the waste material. It has been found that steel is a suitable material for the walls 26 and the floor 24 because of its wearability (i.e., durability), strength, and its relatively good ability to conduct heat.

A steel sheet product which was not galvanized has been found to be unsuitable, if used without paint, because the steel rapidly rusts. It was found that, if the inner surfaces 48, 49 are rusty, the waste material tends not to flow freely out of the bin. However, if the inner surfaces 48, 49 are painted with a suitable rust-inhibiting paint providing a gloss finish, the waste flows relatively easily out of the bin. It is anticipated that galvanized steel sheet would also work well.

Preferably, the floor and walls of the bin are positioned substantially orthogonally to each other (FIG. 8). However, as can be seen in FIG. 9, in an alternative embodiment, the walls 26 and the floor 24 define an obtuse angle. It is anticipated that the waste material tends to flow out of the bin 22 more easily (i.e., when the bin 22 is substantially inverted, or partially inverted) if the walls form an obtuse angle with the floor. However, manufacturing costs are higher if the walls and the floor define an obtuse angle.

Preferably, the frame subassembly 32 includes cross-members 39 (FIGS. 3A, 3B) positioned to add strength. The bin 22 is at least partially supported by the cross-members 39 (FIGS. 8, 9, 9a).

Preferably, and as shown in FIGS. 1, 2, and 5-9, the cover subassembly 41 at least partially defines the cavity 28. In the preferred embodiment, the cover subassembly 41 includes polyethylene portions. However, the cover subassembly 41 can be made of any suitable material.

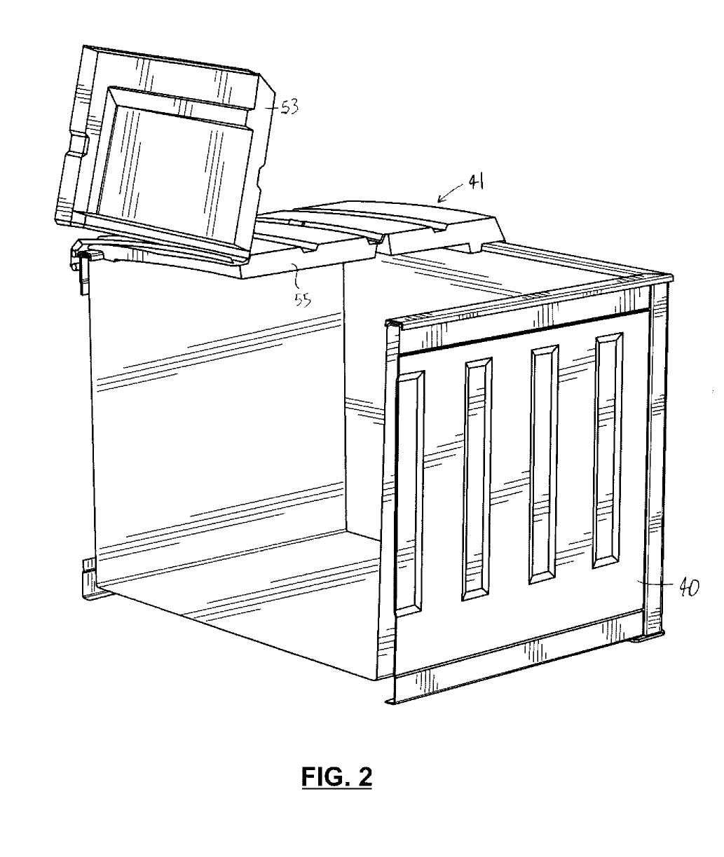

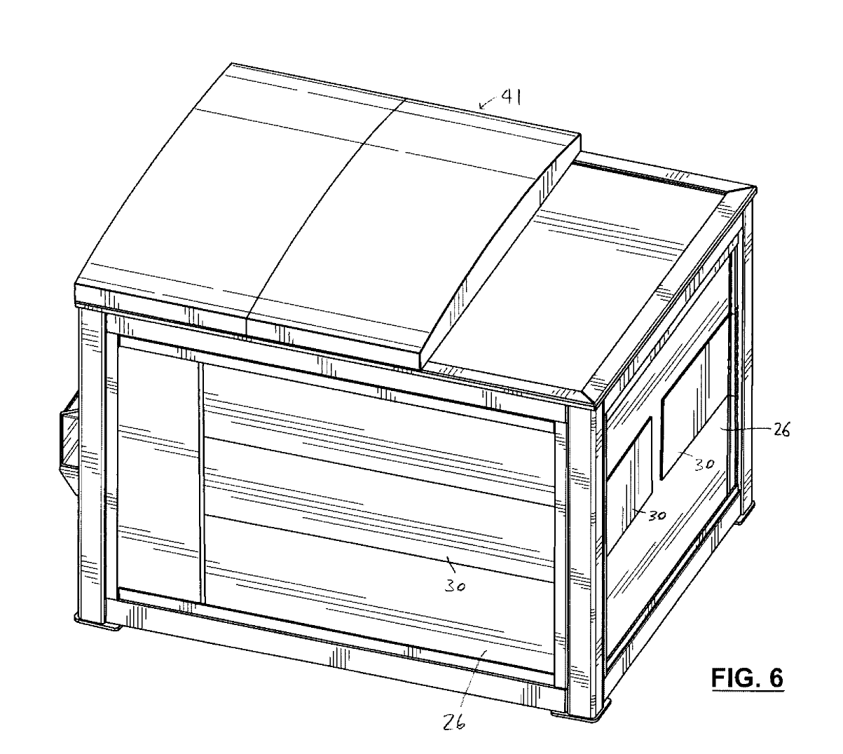

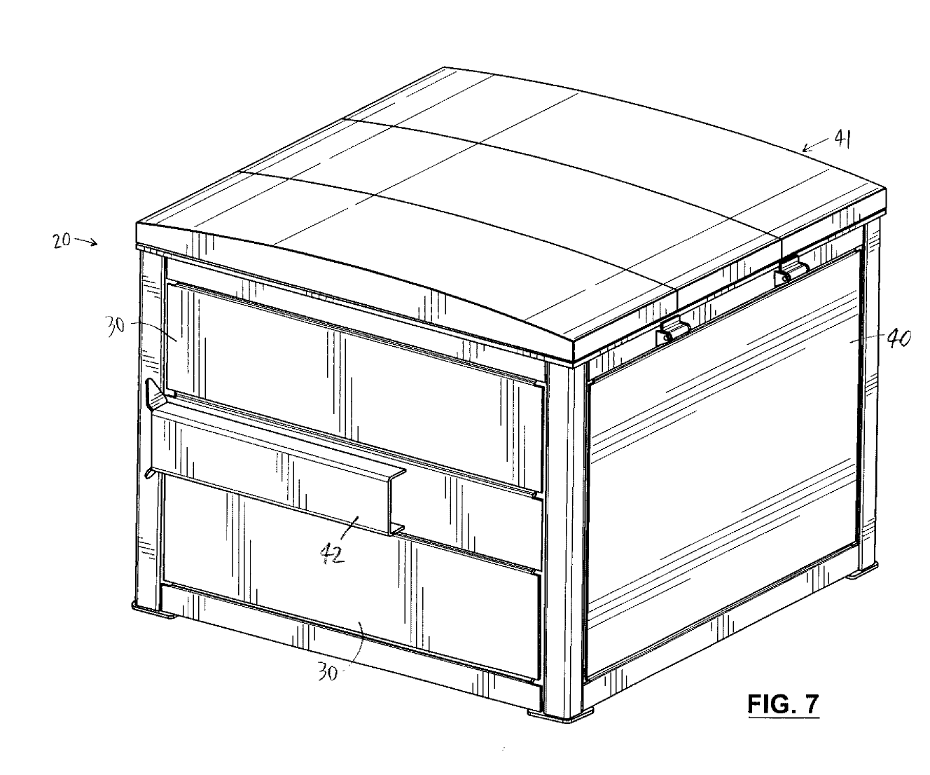

The cover subassembly 41 preferably includes at least a first cover segment 53 and a second cover segment 55 which are independently movable relative to each other between an open position, and which ingress to and egress from the cavity 28 is permitted, and a closed position, in which ingress to and egress from the cavity 28 is prevented thereby (FIG. 2). This is advantageous because the user only needs to lift one of the cover segments in order to put waste material into the bin 22, i.e., instead of having to raise the entire cover subassembly 41. The cover subassembly 41 preferably is pivotable about hinges (FIGS. 6, 7) attached at the back of the bin. As is known in the art, the first and second cover segments 53, 55 are releasably attachable together, so that the first and second cover segments 53, 55 are then movable together, e.g. when the bin is unloaded.

As shown in FIGS. 2 and 6, in one embodiment, the cover subassembly 41 includes three cover segments. It will be understood that the cover subassembly 41 is incompletely shown in FIG. 6 (one of the cover segments is not shown) and shown in a cut-away view in FIG. 2 for simplicity of illustration.

It is also preferred that the cover subassembly 41 is insulated with thermal insulation 57 (FIG. 8), so that the temperature of the contents of the cavity 28 is more easily controllable, at least to an extent. Different types of suitable insulation would be known to those skilled in the art. For example, the cover subassembly 41 may be filled with thermal insulation 57 in the form of cellulose fibre or polyurethane foam. However, the waste bin assembly 20 also has been found to perform well even where the cover subassembly 41 is not insulated.

In the preferred embodiment, the waste bin assembly additionally includes the panels 40 (FIGS. 1, 2) which are receivable in the apertures 38 (FIGS. 3A, 3B). Preferably, the panels 40 are secured in the apertures 38 using any suitable fasteners and fastening arrangements, as would be known by those skilled in the art. For instance, in one embodiment, the panels 40 are secured to the frame subassembly by ratchet-type plastic plugs (not shown). The plugs are pushed into preformed holes (not shown) in the panels 40. When the panels 40 are positioned in the apertures 38, the holes in the panels 40 are positioned to register with holes (not shown) in the frame subassembly 32, so that plugs pushed into the holes in the panels 40 will lodge in the holes in the frame subassembly 32. It will be understood that the plugs are relatively inexpensive and permit relatively easy removal and replacement of the panels 40, if desired. However, in the preferred embodiment, one of the panels 40 is held in position by screws so that it is readily removable, as will be described below.

The panels 40 preferably are of relatively light weight and provide an aesthetic effect, or are easily formed or decorated to provide such an effect if desired. Preferably, the panels are also relatively durable, and generally resistant to corrosion and fading. Although any suitable material could be used, the panels 40 are preferably formed of polyethylene.

It will be appreciated by those skilled in the art that the panels 40 have the significant advantage of replacability over the waste bins of the prior art. For example, any of the panels 40 which happen to be damaged in ordinary use are readily replaceable by a new panel.

In one embodiment, the heating element 30 requires a “step-down” transformer, because the voltage required is much less than the ordinary voltage (110 v) of electricity supplied to households and commercial establishments. Also, fuses preferably are provided (i.e., for the electric circuits including the heating elements in the waste bin assembly) in a small fuse-box. Preferably, the transformer and the fuses are mounted behind a panel 68 (FIG. 1) which is formed to accommodate the transformer and the fuses and which is also easily removable, to facilitate maintenance and repairs on those elements. Such panel 68 may, for instance, be secured to the frame subassembly 22 by screws rather than plugs, for easier removal.

It will be understood that the extent to which the waste material is heated is an important consideration. For instance, although the parts of the waste material which are in contact with the floor and walls of the bin 22 should be heated sufficiently that such parts do not freeze to the floor and walls, it may be that other parts of the waste material (i.e., more centrally positioned parts thereof) freeze. Similarly, it will also be understood that the waste material should not be heated too much. For instance, if the waste material is overheated, it becomes somewhat dehydrated, and tends to adhere to the floor and walls. Also, if the waste material is maintained at a temperature well above freezing, energy is being wasted. Accordingly, it is important that the appropriate amount of heat be provided to the waste material. The appropriate amount of heat is, at least in part, determined by the ambient temperature outside the cavity 28. Various heating elements are known which provide the appropriate amount of heat, whether due to the heating element or controls thereof.

It is preferred that the heating elements are self-regulating. A self-regulating heating element does not require the controls used for other heating elements, thereby resulting in lower costs. Preferably, the heating element is self-regulating because it includes semi-conductive material having a positive thermal coefficient of resistance. Accordingly, as the temperature of the heating element increases, the resistance of the semi-conductive material substantially increases. (Such a heating element with an adhesive coating is disclosed, for example, in U.S. Pat. No. 5,961,869 (Irgens).)

For example, certain heating elements rated at 30 volts and supplied by Electro Plastics Inc. have been found to provide an appropriate amount of heat for typical winter conditions in southwestern Ontario, when the heating elements are properly controlled. Each such heating element includes a sheet of polyethylene which is approximately 1.2 mm. thick and about 22.9 cm. (9 inches) wide. In practice, if the heating element 30 includes five individual strips spaced apart so that they are positioned approximately equidistant from each other, then sufficient heat is provided (FIG. 9). In each such individual heating element strip, electrodes are positioned on opposite sides of the polyethylene sheet, and heat is generated when current passes through the polyethylene, from one electrode to another. The polyethylene has a suitable positive thermal coefficient of resistance. However, the Electro Plastic heating elements are only examples of suitable heating elements, and it will be understood that any heating element(s) controlled to provide an appropriate amount of heat (i.e., sufficient for the purposes hereof, but not excessive) would be suitable.

As can be seen in FIGS. 8, 9, and 9a, a layer of electrical insulation 74 is positioned between the heating element 30 and an underside 75 of the floor 24, if necessary. For example, where the heating element 30 is the Electro Plastic heating element referred to above, it has been found that the electrical insulation 74 should be positioned between the floor 24 and the heating element 30. Preferably, the electrical insulation 74 is a thin sheet of polyethylene, for example, a sheet having a thickness of approximately 0.2032 mm. (0.008 inch).

In addition, a layer of thermal insulation 76 is positioned underneath, and in direct contact with, the heating element 30. Different types of insulation which would be suitable would be known to those skilled in the art. For example, construction grade styrofoam (i.e., polystyrene) having a thickness of approximately 38 mm. (1.5 inches) would be suitable. As can be seen in FIGS. 8, 9, and 9a, the insulation layer 76 preferably is positioned on, and supported by, the cross-members 39.

The heating element(s) 30 may be positioned on one or more walls, on the floor, or on any suitable combinations thereof. For instance, in FIG. 6, panels (and insulation) are not shown in order to show heating elements 30 positioned on walls 26 of the bin 22.

In use, a user (not shown) lifts one of the first and second cover segments 53, 55 to provide access to the cavity 28, and inserts the waste materials into the cavity 28. The waste materials are heated by the heating element 30 so that the waste materials do not freeze and thereby become attached to the interior surfaces of the bin.

In order to unload the waste materials, the waste disposal truck with forks 43 pushes the forks 43 into the tubes 42 and the waste bin assembly 20 is then upended, so that the waste material moves out of the bin under the influence of gravity and into the waste disposal truck (FIG. 10). The emptied waste bin assembly is then returned to the upright position (FIG. 1).

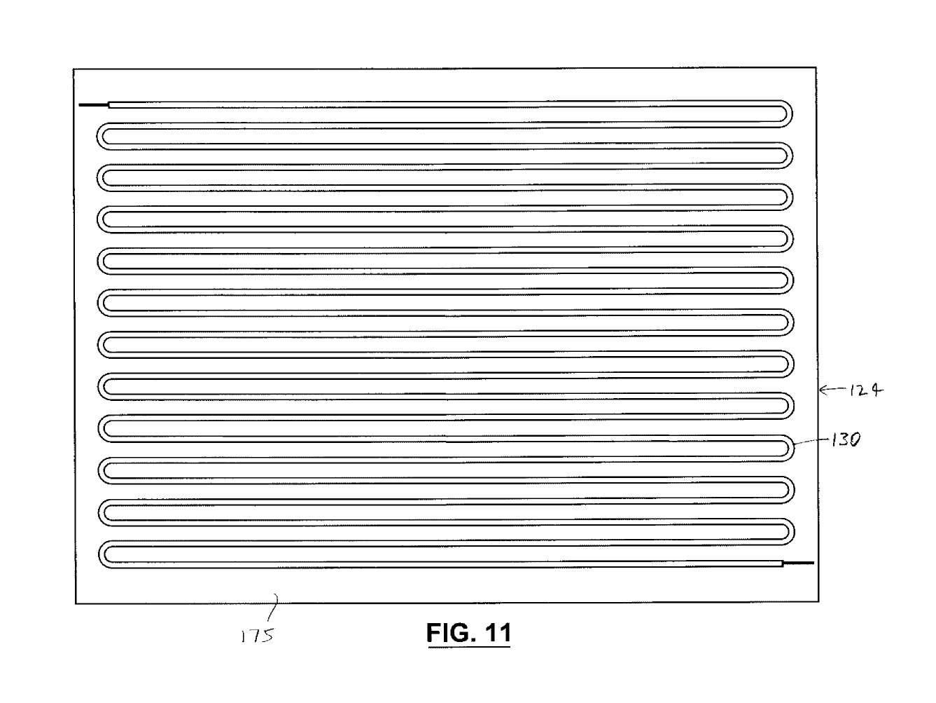

An alternative embodiment of the waste bin assembly and the bin of the invention is disclosed in FIG. 11. Elements are numbered in FIG. 11 so as to correspond to like elements shown in FIGS. 1-10.

In FIG. 11, a floor 124 is shown with a heating element 130 positioned on an outer surface 175 of the floor. The heating element 130 is in the form of an elongate element, and preferably is self-regulating. For example, a “heat tracer” heating cable, available from Drexan Corporation is a suitable heating element 130. Preferably, the heating cable includes a relatively narrow strip of material having a positive thermal co-efficient of resistance, positioned between two electrodes. Among the advantages of using the heating element 130 is that it provides a relatively even heat distribution over the area where the heating element 130 is located. Also, the heating element 130 does not require a transformer, thereby lowering manufacturing cost and eliminating a component (the transformer) which may be subject to failure.

The heating element may be attached to the underside of the floor 124 by any suitable means. After it has been attached, insulation (not shown) is sprayed over the heating element 130. The heating element 130 may be positioned on the side walls as well as on the floor, or alternatively, it may be advantageous in some situations to have the heating element 130 attached to the walls.

In another embodiment, the frame subassembly 32 additionally includes four or more upper transverse members 70 (FIGS. 3A, 3B). Preferably, the upper transverse members 70 are spaced apart from the four transverse members 36 by a preselected distance. The upper transverse members 70 also connect with the posts 34, and add to the stability of the frame subassembly 32.

As can also be seen in FIG. 3B, the frame subassembly 32 preferably includes two middle transverse members 72. Each of the middle transverse members 72 joins at least two of the posts 34 to each other. Also, the middle transverse members 72 are positioned substantially parallel to each other.

Accordingly, although the middle transverse members 72 strengthen the frame subassembly 32, the primary purpose thereof is to provide a strengthened base on which the tubes 42 can be positioned. Preferably, each tube 42 is mounted on one of the middle transverse members 72 respectively, so that the forks of the waste disposal truck are receivable in the tubes 42, to permit unloading of the waste bin into a front-loading waste disposal truck.

The frame subassembly 32 is manufactured by, first, connecting the transverse members 36 to the posts 34 by any suitable means. Preferably, the transverse members and the posts are welded together using any suitable procedure, as is known by those skilled in the art. The bin 22 is generally assembled before it is inserted into the frame subassembly 32. After the bin 22 is positioned in the frame 32, the panels 40 are inserted into the apertures 38 and affixed to the frame subassembly 32 by any suitable means.

Any element in a claim that does not explicitly state “means for” performing a specified function, or “step for” performing a specific function, is not to be interpreted as a “means” or “step” clause as specified in 35 U.S.C. §112, paragraph 6.

It will be appreciated by those skilled in the art that the invention can take many forms, and that such forms are within the scope of the invention as claimed. Therefore, the spirit and scope of the appended claims should not be limited to the descriptions of the preferred versions contained herein.

We claim:

1. A waste bin assembly for the collection and storage of waste material, the waste bin assembly comprising:
a bin comprising:
a floor;
at least one wall extending from the floor to at least partially define a cavity;
at least one of the floor and said at least one wall comprising
at least one heating element, for heating the waste material in the cavity;
a frame subassembly for supporting the bin, the frame subassembly comprising at least two posts and at least one transverse member connecting said posts; and
said at least one transverse member and said at least two posts defining at least one aperture in which at least one panel is positionable.

2. A waste bin assembly according to claim 1 in which said at least one panel comprises polyethylene.

3. A waste bin assembly according to claim 1 additionally comprising at least two tubes mounted on the frame subassembly, for receiving forks of a garbage truck.

4. A waste bin assembly according to claim 3 additionally comprising at least one cap movable between a blocking position, in which said at least one cap prevents one of said forks from entering one of said tubes, and a receiving position, in which said one of said forks is receivable in said one of said tubes.

5. A waste bin assembly according to claim 1 in which said at least one wall comprises thermal insulation to retard heat transfer out of the cavity.

6. A waste bin assembly according to claim 1 in which the floor comprises thermal insulation to retard heat transfer out of the cavity.

7. A waste bin assembly according to claim 1 in which an obtuse angle is defined by said at least one wall and the floor.

8. A waste bin assembly according to claim 1 in which said at least one heating element is self-regulating.

9. A waste bin assembly according to claim 1 in which said at least one heating element comprises at least two electrodes connected by a material having a positive thermal coefficient of resistance.

10. A waste bin for the collection and storage of waste material, the waste bin comprising:
a floor;
at least one wall extending from the floor to at least partially define a cavity; and
at least one of the floor and said at least one wall comprising at least one heating element, for heating the waste material in the cavity.

11. A waste bin according to claim 10 in which said at least one wall comprises thermal insulation to retard heat transfer out of the cavity.

12. A waste bin according to claim 10 in which the floor comprises thermal insulation to retard heat transfer out of the cavity.

13. A waste bin according to claim 10 in which an obtuse angle is defined by said at least one wall and the floor.

14. A waste bin according to claim 10 in which said at least one heating element is adapted for limiting freezing of the waste material.

15. A waste bin according to claim 10 in which said at least one heating element is self-regulating.

16. A waste bin assembly according to claim 10 in which said at least one heating element comprises two electrodes connected by a semi-conductive material having a positive thermal coefficient of resistance.

17. A waste bin according to claim 10 additionally comprising a cover subassembly positioned on said at least one wall, the cover subassembly at least partially defining the cavity.

18. A waste bin according to claim 17 comprising at least a first cover segment and a second cover segment, each of said first and second cover segments being independently movable relative to each other between an open position, in which ingress to and egress from the cavity of waste material is permitted, and a closed position, in which ingress to and egress of waste material is prevented thereby.

19. A waste bin according to claim 18 in which the cover subassembly comprises thermal insulation.

20. A waste bin according to claim 17 in which the cover subassembly is movable between an unloading position, in which ingress and egress of the waste material into and out of the cavity is permitted, and a covered position, in which the cavity is substantially covered by the cover subassembly.
